(19) United States
(12) Patent Application Publication
(10) Pub. No.: US 2014/0181439 A1
(43) Pub. Date: Jun. 26, 2014

(54) Memory system

(71) Applicant: SK hynix Inc., Icheon-si (KR)

(72) Inventors: Young Suk MOON, Icheon-si (KR); Hyung Dong Lee, Icheon-si (KR); Yong Kee Kwon, Icheon-si (KR); Hyung Gyun Yang, Icheon-si (KR)

(21) Appl. No.: 13/846,796

(22) Filed: Mar. 18, 2013

(30) Foreign Application Priority Data
Dec. 24, 2012 (KR) 10-2012-0151748

(51) Int. Cl. G06F 3/06

(52) U.S. Cl. CPC G06F 3/065; G06F 3/0614; G06F 3/0683
USPC 711/162

(57) ABSTRACT

A memory system includes a processor, one or more volatile memory dies stacked with the processor and one or more nonvolatile memory dies stacked with the processor and the volatile memory dies. The processor transfers data stored in the volatile memory die to the nonvolatile memory die in response to a backup signal, and transfers the data stored in the nonvolatile memory die to the volatile memory die in response to a recovery signal.

### CROSS-REFERENCES TO RELATED APPLICATION

The present application claims priority under 35 U.S.C. §119(a) to Korean application number 10-2012-0151748, filed on Dec. 24, 2012, in the Korean Intellectual Property Office, which is incorporated herein by reference in its entirety.

### BACKGROUND

1. Technical Field

Various embodiments generally relate to a semiconductor apparatus, and more particularly, to a memory system including a plurality of chips or dies stacked therein.

2. Related Art

In order to increase the integration degree of a semiconductor apparatus, a three-dimensional (3D) semiconductor apparatus in which a plurality of chips are stacked and packaged has been developed. The 3D semiconductor apparatus may include two or more chips stacked in a vertical direction, thereby realizing the maximum integration degree in the same space.

Furthermore, in order to improve operation performance, a memory system including a memory controller or processor has been developed. The memory system includes a memory core to store data, wherein the memory core communicates with a host through the memory controller or processor.

Meanwhile, since a memory apparatus such as a dynamic random-access memory (DRAM) has a characteristic of a volatile storage device, the memory apparatus performs a refresh operation to preserve data stored in a memory cell at each predetermined period (that is, retention time). The memory apparatus is vulnerable to deterioration. Therefore, as the temperature of the memory apparatus increases, the refresh operation must be performed at a shorter period. Accordingly, many techniques for changing the refresh period depending on the temperature of the memory apparatus have been proposed.

FIG. 1 schematically illustrates a conventional memory system when a processor is in a sleeping mode. Referring to FIG. 1, a plurality of stacked memory dies MEMORY1 to MEMORY4 and the processor construct a memory system. The processor communicates with a host (not illustrated), and relays communication between the stacked memory dies MEMORY1 to MEMORY4 and the host.

When the processor is in the sleeping mode, the temperature of the processor is not increased much. Therefore, the temperatures of the stacked memory dies MEMORY1 to MEMORY4 are not changed much. For example, as illustrated in FIG. 1, the first memory die MEMORY1 may be heated to 36° C., the second memory die MEMORY2 may be heated to 34° C., the third memory die MEMORY3 may be heated to 32° C., and the fourth memory die MEMORY4 may be heated to 30° C. In this case, a retention time corresponding to a period at which a refresh operation must be performed may be set in the range of 74 ms to 80 ms. Therefore, a small amount of current is consumed during the refresh operation.

FIG. 2 schematically illustrates the conventional memory system when the processor operates. Referring to FIG. 2, when the processor operates, the temperatures of the memory dies MEMORY1 to MEMORY4 may be rapidly increased. For example, as illustrated in FIG. 2, the third memory die MEMORY3 may be heated to 110° C., the fourth memory die MEMORY4 may be heated to 90° C., and the first and second memory dies MEMORY1 and MEMORY2 may be heated to 120° C. and 110° C., respectively.

As the temperatures of the first and second memory dies MEMORY1 and MEMORY2 are increased to 120° C. and 110° C., respectively, the first and second memory dies MEMORY1 and MEMORY2 require a very short data retention time of 10 ms to 25 ms. Accordingly, since the memory dies must perform a refresh operation at a short period, the amount of current consumed during a refresh operation is rapidly increased. Furthermore, as a data storage region to be refreshed is increased, the bandwidth of a channel to input and output data is significantly decreased.

### SUMMARY

A memory system which transfers data stored in a volatile memory die to a nonvolatile memory die as a backup such that the volatile memory die does not need to perform a refresh operation is described herein.

In an embodiment of the present invention, a memory system includes: a processor; one or more volatile memory dies stacked with the processor; and one or more nonvolatile memory dies stacked with the processor and the volatile memory dies, wherein the processor transfers data stored in the volatile memory die to the nonvolatile memory die in response to a backup signal, and transfers the data stored in the nonvolatile memory die to the volatile memory die in response to a recovery signal.

In an embodiment of the present invention, a memory system includes: a processor configured to communicate with a host; a logic die configured to communicate with the processor; one or more volatile memory dies stacked with the logic die; and one or more nonvolatile memory dies stacked with the logic die and the volatile memory dies, wherein the logic die transfers data stored in the volatile memory die to the nonvolatile memory die in response to a backup signal, and transfers the data stored in the nonvolatile memory die to the volatile memory die in response to a recovery signal.

In an embodiment of the present invention, a memory system includes: a processor; and one or more volatile memory dies stacked with a nonvolatile memory die and the processor, wherein the processor performs a data transfer operation when a backup signal and/or a recovery signal is generated.

### BRIEF DESCRIPTION OF THE DRAWINGS

Features, aspects, and embodiments are described in conjunction with the attached drawings, in which:

FIG. 1 schematically illustrates a conventional memory system and temperatures and retention times of memories when a processor is in a sleeping mode;

FIG. 2 schematically illustrates the conventional memory system and temperatures and retention times of memories when the processor operates;

FIG. 3 is a block diagram illustrating the configuration of a memory system according to one embodiment of the present invention;

FIG. 4 is diagram to conceptually explain the operation of an address mapping unit of FIG. 3;

FIG. 5 is a diagram illustrating the operation of the address mapping unit when data are transferred from nonvolatile memory dies to a nonvolatile memory die;

FIG. 6 is a diagram illustrating the operation of the address mapping unit when data are recovered from the nonvolatile memory die into the volatile memory dies; and

FIG. 7 is a diagram illustrating the configuration of a memory system according to another embodiment of the present invention.

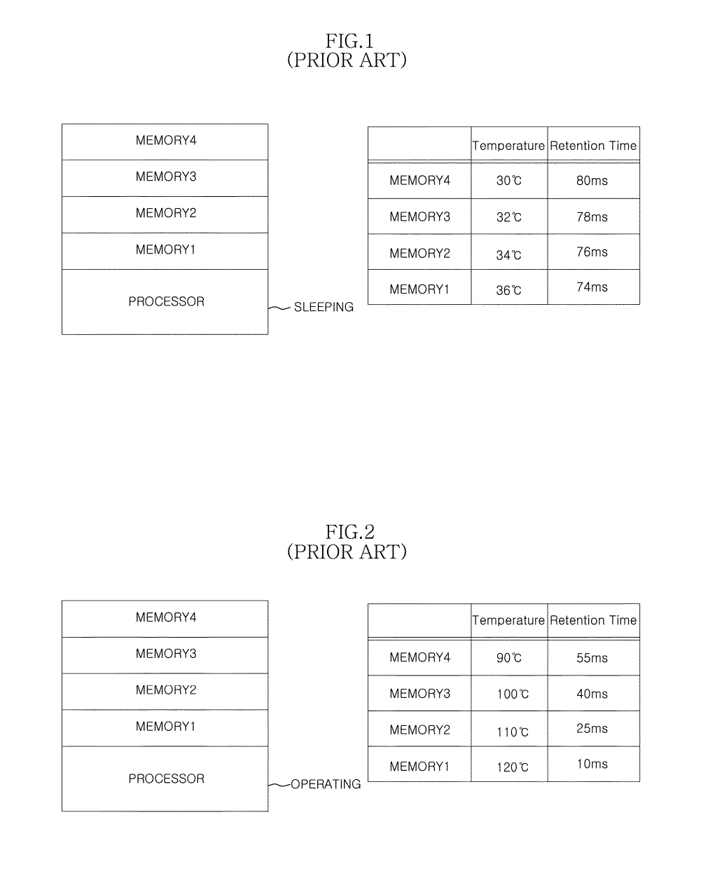

### DETAILED DESCRIPTION

Hereinafter, a memory system according to the present invention will be described below with reference to the accompanying drawings through exemplary embodiments.

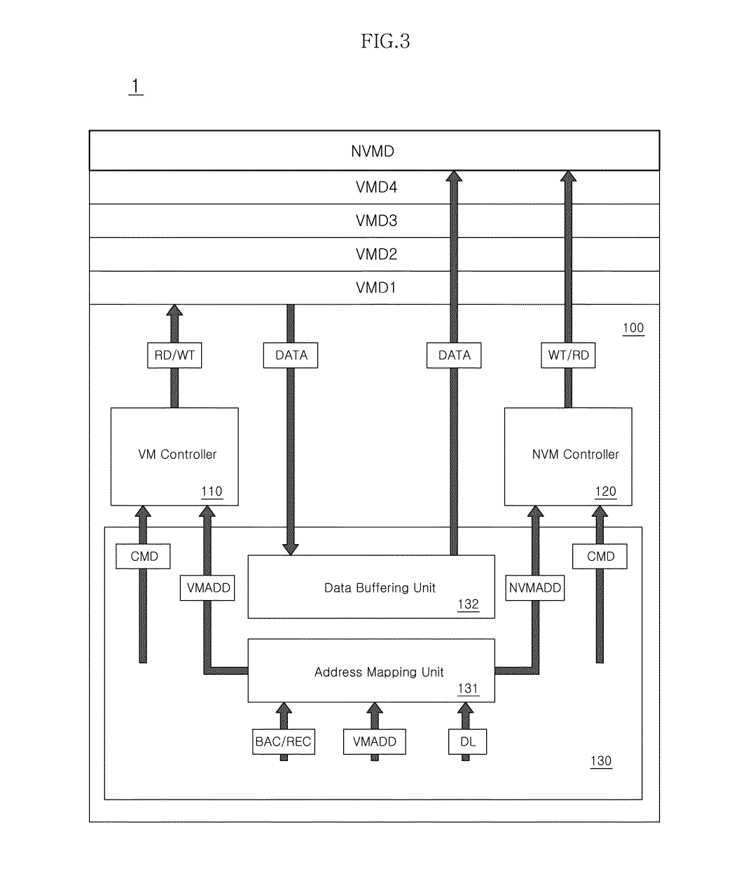

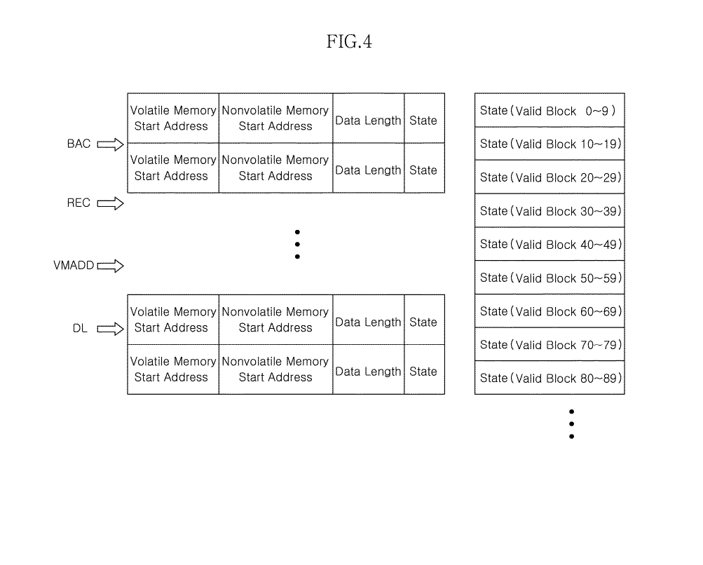

In FIG. 3, the memory system 1 includes a processor, one or more volatile memory dies VMD, and one or more nonvolatile memory dies NVMD. Referring to FIG. 3, the memory system 1 includes four volatile memory dies VMD1 to VMD4 and one nonvolatile memory die NVMD. The processor 100 is configured to relay communication between a host (not illustrated) and the volatile memory dies VMD1 to VMD4 and the nonvolatile memory die NVMD.

The volatile memory dies VMD1 to VMD4 may include memory chips such as a dynamic random-access memory (DRAM). The nonvolatile memory die NVMD may include a memory chip such as a phase change memory, a flash memory, a resistive memory, and a magnetic memory having a nonvolatile data storage characteristic because memory cells included therein are not implemented as capacitors.

The processor 100, the volatile memory dies VMD1 to VMD4, and the nonvolatile memory die NVMD are stacked to construct the memory system 1. The volatile memory dies VMD1 to VMD4 may be stacked with the processor 100, and the nonvolatile memory die NVMD may be stacked with the processor 100 and the volatile memory dies VMD1 to VMD4. For example, the first to fourth nonvolatile memory dies VMD1 to VMD4 may be sequentially stacked over the processor 100, and the nonvolatile memory die VMD1 may be stacked at the uppermost part over the processor 100 and the nonvolatile memory dies VMD1 to VMD4. That is, the nonvolatile memory die NVMD may be stacked over the volatile memory die VMD4.

The processor 100 may perform a data transfer operation in response to a backup signal BAC and a recovery signal REC. The processor 100 may transfer data stored in the volatile memory dies VMD1 to VMD4 to the nonvolatile memory die NVMD in response to the backup signal BAC. Furthermore, the processor 100 may transfer the data stored in the nonvolatile memory die NVMD to the volatile memory dies VMD1 to VMD4 in response to the recovery signal REC. In one embodiment, the backup signal BAC and the recovery signal REC may be generated depending on the temperatures of the volatile memory dies VMD1 to VMD4. The processor 100 may generate the backup signal BAC when the volatile memory dies VMD1 to VMD4 are heated to a predetermined temperature or more so as to decrease a retention time corresponding to a period at which a refresh operation is to be performed. Furthermore, the processor 100 may generate the recovery signal REC when the temperature of the volatile memory dies VMD1 to VMD4 is decreased to a predetermined temperature or less so as to increase the retention time. For example, the processor 100 may obtain information on whether the temperature of the nonvolatile memory dies VMD1 to VMD4 have reached the predetermined temperature or not, through temperature sensors (not illustrated) provided in the respective volatile memory dies VMD1 to VMD4. When the volatile memory dies VMD1 to VMD4 are heated to the predetermined temperature or more, the period of the refresh operation for preserving data is significantly decreased. Therefore, the data stored in the volatile memory dies VMD1 to VMD4 of the memory system 1 are transferred to the nonvolatile memory die NVDM such that the heated volatile memory dies do not need to perform a refresh operation.

In another embodiment, the backup signal BAC and the recovery signal REC may be generated when access to the volatile memory dies VMD1 to VMD4 is not frequently performed. That is, when the volatile memory dies VMD1 to VMD4 do not perform a lot of operations, the processor 100 may generate the backup signal BAC. When access to the volatile memory dies VMD1 to VMD4 is not frequently performed, the processor 100 may generate the backup signal BAC to reduce the amount of current consumed during a refresh operation of the volatile memory dies VMD1 to VMD4. The processor 1 may generate the backup signal BAC to transfer the data stored in the volatile memory dies VMD1 to VMD4 to the nonvolatile memory die NVMD, thereby removing the current consumption caused by the refresh operation of the volatile memory dies VMD1 to VMD4.

The processor 100 provides an address signal to the volatile memory dies VMD1 to VMD4 and the nonvolatile memory die NVMD to transfer the data. When the data are transferred from the volatile memory dies VMD1 to VMD4 to the nonvolatile memory die NVMD, the processor 100 first generates a nonvolatile memory address signal NVMADD corresponding to a volatile memory address signal VMADD, and stores the address correspondence information. The volatile memory address signal VMADD has information on memory storage spaces of the volatile memory dies VMD1 to VMD4 in which the data are stored, and may be stored in the processor 100 during a write operation for the volatile memory dies VMD1 to VMD4. The volatile memory address signal VMADD is provided to the volatile memory dies VMD1 to VMD4, and the nonvolatile memory address signal NVMADD is provided to the nonvolatile memory die NVMD. According to the volatile memory address signal VMADD, the data stored in the data storage spaces of the volatile memory dies VMD1 to VMD4 are outputted, and according to the nonvolatile memory address signal NVMADD, the data may be inputted to a data storage space of the nonvolatile memory die NVMD.

Then, when the processor 100 transfers the data from the nonvolatile memory die NVMD to the volatile memory dies VMD1 to VMD4, the nonvolatile memory address signal NVMADD is provided to the nonvolatile memory die NVMD based on the address correspondence information. The volatile memory address signal VMADD corresponding to the nonvolatile memory address signal NVMADD is provided to the volatile memory dies VMD1 to VMD4. Therefore, according to the nonvolatile memory address signal NVMADD the data stored in the data storage space of the nonvolatile memory die NVMD is outputted, and according to the volatile memory address signal VMADD, the data is inputted to the data storage spaces of the nonvolatile memory dies VMD1 to VMD4.

The processor 100 includes a volatile memory controller 110, a nonvolatile memory controller 120, and an arbiter 130. The volatile memory controller 110 is configured to control the volatile memory dies VMD1 to VMD4, and the nonvolatile memory controller 120 is configured to control the nonvolatile memory die NVMD. The arbiter 130 is configured to relay communication between a host (not shown) and the volatile memory controller 110, and the nonvolatile memory controller 120. Furthermore, the arbiter 130 may provide a command CMD to the volatile memory controller 110 and the nonvolatile memory controller 120 according to the backup signal BAC and the recovery signal REC. Furthermore, the arbiter 130 provides a volatile memory address signal VMADD, having information on a memory storage space in which data are effectively stored, to the volatile memory controller 110. The arbiter 130 also provides a nonvolatile memory address signal NVMADD generated in response to the volatile memory address signal VMADD to the nonvolatile memory controller 120.

When the arbiter 130 provides a command CMD to the volatile memory controller 110 and the nonvolatile memory controller 120 according to the backup signal BAC, the volatile memory controller 110 generates a read signal RD in response to the command CMD, and data DATA may be read from the volatile memory dies VMD1 to VMD4 in response to the read signal RD and the volatile address signal VMADD. The nonvolatile memory controller 120 generates a write signal WT when receiving the command CMD, and the data DATA read from the volatile memory dies VMD1 to VMD4 may be written into the nonvolatile memory die NVMD in response to the write signal WT and the nonvolatile memory address signal NVMADD corresponding to the volatile memory address signal VMADD.

When the arbiter 130 provides the command CMD to the volatile memory controller 110 and the nonvolatile memory controller 120 according to the recovery signal REC, the nonvolatile memory controller 120 generates a read signal RD in response to the command CMD. In addition, the data DATA may be read from the nonvolatile memory die NVMD in response to the read signal RD and the nonvolatile memory address signal NVMADD corresponding to the volatile memory address signal VMADD. The volatile memory controller 110 generates a write signal WT in response to the command CMD, and the data DATA read from the nonvolatile memory die NVMD may be written into the volatile memory dies VMD1 to VMD4 in response to the write signal WT and the volatile memory address signal VMADD.

The arbiter 130 includes an address mapping unit 131. The address mapping unit 131 is configured to provide the volatile memory address signal VMADD to the volatile memory controller 110 in response to the backup signal BAC. The volatile memory address signal VMADD may include an address signal having information on a memory storage space of a volatile memory die VMD in which data are effectively stored during a write operation of a volatile memory. The volatile memory address signal VMADD may be stored in the address mapping unit 131 during the write operation of the volatile memory dies VMD1 to VMD4. When the data DATA are transferred from the volatile memory dies VMD1 to VMD4 to the nonvolatile memory die NVMD, the address mapping unit 131 generates a nonvolatile memory address NVMADD corresponding to the volatile memory address signal VMADD, and provides the generated nonvolatile memory address signal NVMADD to the nonvolatile memory controller 120. Furthermore, the address mapping unit 131 stores correspondence information between the volatile memory address signal VMADD and the nonvolatile memory address NVMADD.

When the data DATA are transferred from the nonvolatile memory die NVMD to the volatile memory dies VMD1 to VMD4, the address mapping unit 131 outputs the volatile memory address signal VMADD; and outputs the nonvolatile memory address signal NVMADD corresponding to the volatile memory address signal VMADD to the volatile memory controller 110 and the nonvolatile memory controller 120, respectively, in response to the recovery signal REC, based on the correspondence information.

The arbiter 130 may further include a data buffering unit 132. The data buffering unit 132 is configured to delay the data DATA read from the volatile memory dies VMD1 to VMD4 and output the delayed data to the nonvolatile memory die NVMD The data buffering unit 132 may also delay the data DATA read from the nonvolatile memory die NVMD and output the delayed data to the volatile memory dies VMD1 to VMD4. In addition, the data buffering unit 132 may delay the data DATA read from the volatile memory dies VMD1 to VMD4 until the read data DATA are written into the nonvolatile memory die NVMD. On the other hand, the data buffering unit 132 may delay the data DATA read from the nonvolatile memory die NVMD until the read data DATA are actually written into the volatile memory dies VMD1 to VMD4.

FIG. 4 is diagram to conceptually explain the operation of the address mapping unit 131 of FIG. 3. Referring to FIG. 4, the information storage space of the address mapping unit 131 may include a plurality of columns, wherein each of the columns stores address correspondence information, a data length, and use state information of the column. Furthermore, the column stores information on valid blocks which indicate a use state of the data storage space of the nonvolatile memory die NVMD. Each column of the address mapping unit 131 may store volatile memory start address information, nonvolatile memory start address information, data length information, and state information. Furthermore, the address mapping unit 131 may store use state information on the memory storage space of the nonvolatile memory die NVMD, that is, state information of valid blocks.

In FIG. 3, the address mapping unit 131 may receive a backup signal BAC, a recovery signal REC, a volatile memory address signal VMADD, and a data length DL. The address mapping unit 131 generates a nonvolatile memory address signal NVMADD corresponding to the volatile memory address signal VMADD when receiving the backup signal BAC, and stores the address signals VMADD and NVMADD as volatile memory start address signal information and nonvolatile memory start address signal information. Furthermore, based on the nonvolatile memory address signal VMADD, information on the data length DL stored in the memory storage space is stored, and the state information is changed to announce that the column in which the respective pieces of information are stored is being used.

In FIG. 4, according to the data length DL, an valid block capable of storing the data DATA in the storage space of the nonvolatile memory die NVMD is allocated, and use state information of the valid block is stored. For example, when data DATA having a data length DL of 20 are to be transferred from the volatile memory dies VMD1 to VMD4 to the nonvolatile memory die NVMD, the address mapping unit 131 may store the nonvolatile memory address signal VMADD as the volatile memory start address information. In addition, the address mapping unit 131 may store the nonvolatile memory address signal NVMADD corresponding to the volatile memory address VMADD as the nonvolatile memory start address signal information; and allocate valid blocks 0-9 and 10-19 for the data DATA having a data length DL of 20. Furthermore, the address mapping unit 131 changes the state information to announce that the column in which the respective pieces of information are stored (for example, first column) is being used, and stores state information indicating that the valid blocks 0-9 and 10-19 are being used. Furthermore, when data DATA having a data length DL of 10 are to be transferred to the nonvolatile memory die NVMD in response to another volatile memory address signal VMADD, the address mapping unit 131 stores the volatile memory address signal VMADD as volatile memory start address information in another column which is not yet used except for the column which is being used (for example, second column). In addition, the address mapping unit 131 stores a nonvolatile memory address signal NVMADD corresponding to the volatile memory address signal VMADD as nonvolatile memory start address information. Moreover, the address mapping unit 131 allocates valid blocks 20-29 among valid blocks which are not used to the data DATA having a data length DL of 10, and stores the state information. Furthermore, the address mapping unit 131 changes the state information to announce that the second column is being used, and stores state information indicating that the valid blocks 20-29 are being used.

The address mapping unit 131 provides the volatile memory address signal VMADD stored as the volatile memory start address information and the nonvolatile memory address signal NVMADD stored as the nonvolatile memory start address information to the volatile memory controller 110 and the nonvolatile memory controller 120 such that the data DATA of the volatile memory dies VMD1 to VMD4 are transferred to the nonvolatile memory die NVMD.

During a recovery operation of transferring the data stored in the nonvolatile memory die NVMD to the volatile memory dies VMD1 to VMD4, the address mapping unit 131 receives the recovery signal REC. The data recovery operation is performed according to information stored in each column of the information storage space of the address mapping unit 131. When the recovery signal REC is inputted, the address mapping unit 131 provides the nonvolatile memory address signal NVMADD stored as the nonvolatile memory start address information to the nonvolatile memory controller 120. The address mapping unit 131 also provides the volatile memory address signal VMADD corresponding to the nonvolatile memory address signal NVMADD and stored as the volatile memory start address information to the volatile memory controller 110. Accordingly, when data are transferred from the nonvolatile memory die NVMD to the volatile memory dies VMD1 to VMD4, the nonvolatile memory start address information, the volatile memory start address information, and the data length information are deleted from the column, and the state information is changed to indicate that the corresponding column is not used. Furthermore, based on the data length information of the corresponding column, the state information is changed to announce that the valid blocks which have been used are not being used. Then, the data recovery operation may be continuously performed according to information stored in another column.

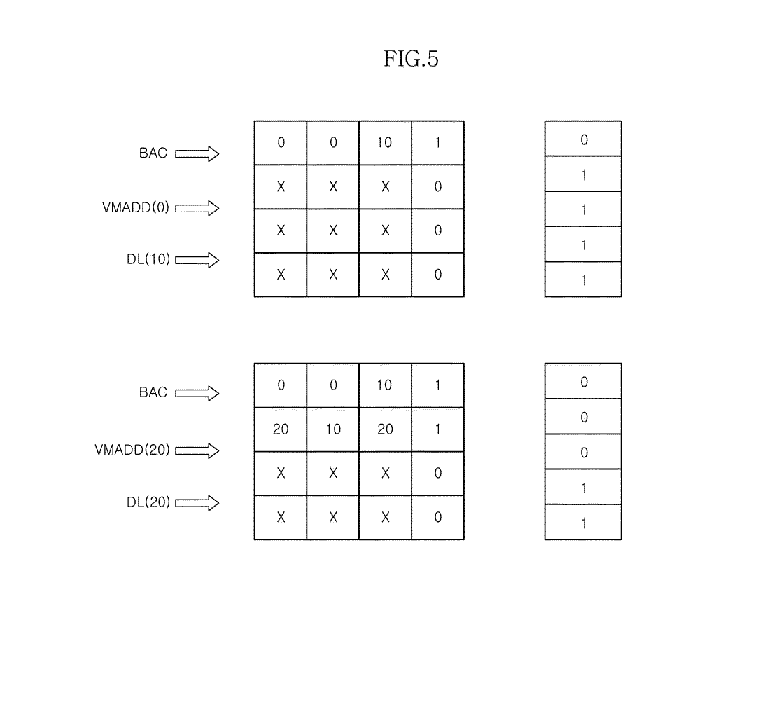

FIG. 5 is a diagram illustrating the operation of the address mapping unit 131 when data are transferred from the nonvolatile memory dies VMD1 to VMD4 to the nonvolatile memory die NVMD. Referring to FIG. 5, when a volatile memory address signal VMADD(0) and a data length DL(10) are inputted with the backup signal BAC, the address mapping unit 131 stores the volatile memory address signal VMADD(0) as volatile memory start address information 0 in a first column. The address mapping unit 131 also stores nonvolatile memory start address information 0 corresponding to the volatile memory start address information 0. Furthermore, the address mapping unit 131 stores the data length information 10, and changes the state information to 1 because the first column is being used. Furthermore, the address mapping unit 131 may allocate valid blocks 0-9 of the nonvolatile memory die NVMD in response to the data length information 10, and change the state information of the valid blocks to 0.

Then, when a volatile memory address signal VMADD(20) and a data length DL(20) are inputted with the backup signal BAC, the address mapping unit 131 stores the volatile memory address signal VMADD(20) as volatile memory start address information 20 in a second column, and stores nonvolatile memory start address information 10 corresponding to the volatile memory start address information 20. Furthermore, the address mapping unit 131 stores the data length information 20, and changes the state information to 1 because the second column is being used. Furthermore, the address mapping unit 131 may allocate valid blocks 10-19 and 20-29 of the nonvolatile memory die NVMD in response to the data length information 20, and change the state information of the valid blocks to 0. Meanwhile, when a column is used, the address mapping unit 131 sets the state information to 1, and when the column is not used, the address mapping unit 131 sets the state information to 0. Furthermore, when a valid block is used, the address mapping unit 131 sets the state information to 0, and when the valid block is not used, the address mapping unit 131 sets the state information to 1.

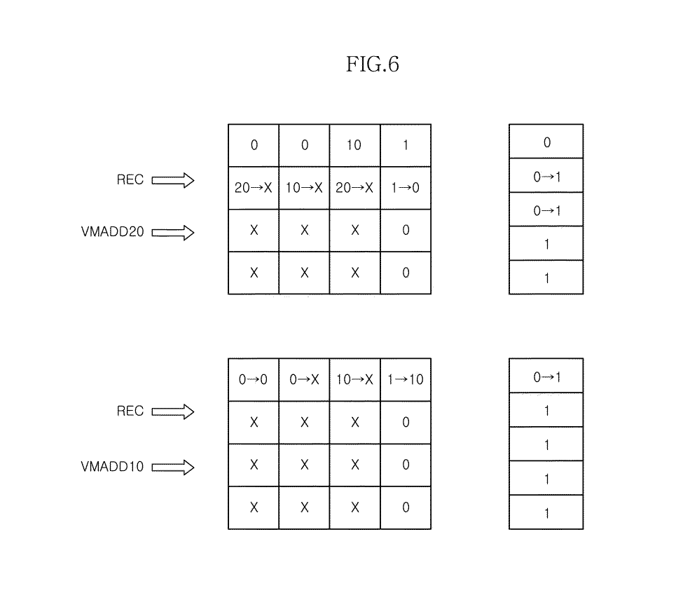

FIG. 6 is a diagram illustrating the operation of the address mapping unit 131 when data are recovered from the nonvolatile memory die NVMD into the volatile memory dies VMD1 to VMD4. In FIG. 6, when a recovery signal REC and a volatile memory address signal VMADD(20) are inputted, the address mapping unit 131 provides the volatile memory address signal VMADD(20) to the volatile memory controller 110 according to volatile memory start address information 20 stored in a second column. The address mapping unit 131 also provides a nonvolatile memory address signal NVMADD(10) to the nonvolatile memory controller 120 according to the nonvolatile memory start address information 10. Furthermore, the address mapping unit 131 deletes the volatile memory start address information 20 and the nonvolatile memory start address information 10. At this time, the data length information 10 may be deleted together.

When the volatile memory address signal VMADD(20) and the nonvolatile memory address signal NVMADD(10) are provided from the address mapping unit 131 according to the information stored in the second column, the information stored in the second column is deleted. In addition, the use state information is changed to 0 because the second column is not used any more. Furthermore, since data related to the volatile memory address signal VMADD(20) and the nonvolatile memory address signal NVMADD(10) are to be transferred from the nonvolatile memory die NVMD to the volatile memory dies VMD1 to VMD4, the use state information of the valid blocks 10-19 and 20-29 in the data storage space of the nonvolatile memory die NVMD is also changed. That is, to announce that the valid blocks are not used, and the state information is changed from 0 to 1.

Then, when the volatile memory address signal VMADD(0) is inputted, the address mapping unit 131 provides the volatile memory address signal VMADD(0) to the volatile memory controller 110 according to the volatile memory start address information 0 stored in the first column. The address mapping unit 131 also provides the nonvolatile memory address signal NVMADD(0) to the nonvolatile memory controller 120 according to the nonvolatile memory start address information 0 corresponding to the volatile memory start address information 0. Furthermore, the volatile memory start address information 0 and the nonvolatile memory start address information 0 are deleted. At this time, the data length information 10 is deleted together.

When the volatile memory address signal VMADD(0) and the nonvolatile memory address signal NVMADD(0) are provided from the address mapping unit 131 according to the information stored in the first column, the information stored in the first column is deleted. The use state information is changed to 0 because the first column is not used any more. Furthermore, since data related to the volatile memory address signal VMADD(0) and the nonvolatile memory address signal NVMADD(0) are to be transferred from the nonvolatile memory die NVMD to the volatile memory die VMD, the use state information of the valid blocks 0-9 in the data storage space of the nonvolatile memory die NVMD is also changed. That is, to announce that the valid blocks 0-9 are not used and the state information may be changed from 0 to 1.

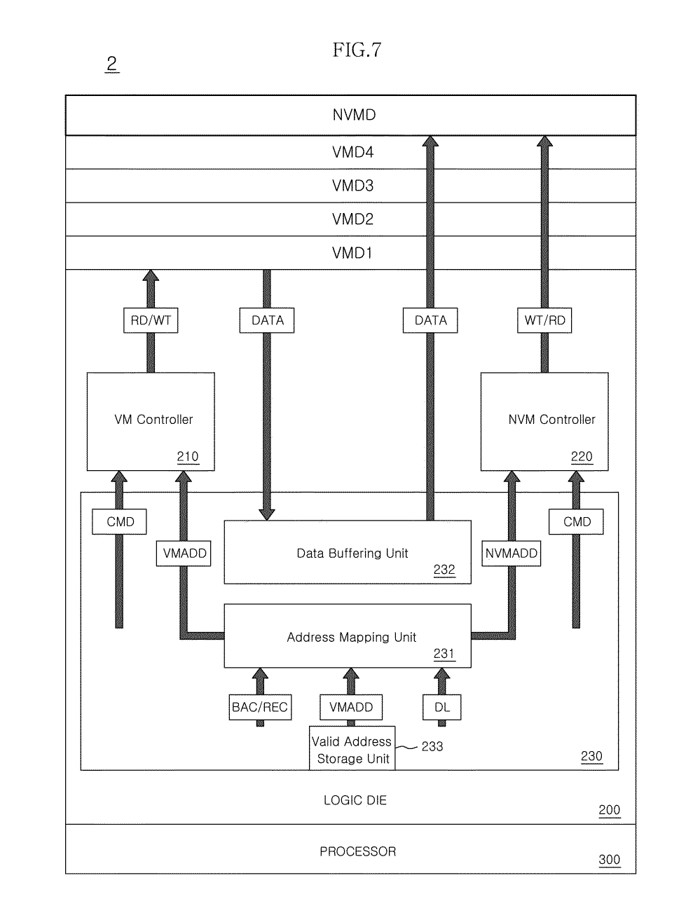

FIG. 7 is a diagram illustrating the configuration of a memory system 2 according to another embodiment of the present invention. Referring to FIG. 7, the memory system 2 includes a logic die 200, a processor 300, one or more volatile memory dies VMD1 to VMD4, and one or more nonvolatile memory dies NVMD. The logic die 200 may be stacked with the processor 300, the volatile memory dies VMD1 to VMD4 may be stacked over the logic die 200, and the nonvolatile memory die NVMD may be stacked over the volatile memory dies VMD1 to VMD4. The memory system 2 is configured by changing the configuration of the memory system 1 of FIG. 3 such that the logic die 200 performs the function of the processor 100 of he memory system of FIG. 3.

The logic die 200 may perform a data transfer operation in response to the backup signal BAC and the recovery signal REC, like the processor 100 of FIG. 3. The logic die 200 may generate the backup signal BAC and the recovery signal REC depending on the temperature of the volatile memory dies VMD1 to VMD4. Alternatively, the logic die 200 may receive the backup signal BAC and the recovery signal REC generated by the processor 300 depending on the temperature of the volatile memory dies VMD1 to VMD4. Furthermore, the logic die 200 includes a valid address storage unit 233. The valid address storage unit 233 is configured to store a valid volatile memory address signal. The valid volatile memory address signal has information on a memory storage space in which data are actually stored by a write operation. Since the processor 300 of FIG. 3 has information on the valid volatile memory address signal, the processor 300 does not need a storage unit for storing the valid volatile memory address signal. However, the logic die 200 includes the valid address storage unit 233; stores the valid volatile memory address signal having information on the memory storage space in which data are stored through a write operation; and provides the volatile memory address signal VMADD to the address mapping unit 231 when the data stored in the nonvolatile memory dies VMD1 to VMD4 are transferred to the nonvolatile memory die NVMD in response to the backup signal BAC.

While certain embodiments have been described above, it will be understood to those skilled in the art that the embodiments described are by way of example only. Accordingly, the memory system described herein should not be limited based on the described embodiments. Rather, the memory system described herein should only be limited in light of the claims that follow when taken in conjunction with the above description and accompanying drawings.

What is claimed is:

1. A memory system comprising:
a processor;
one or more volatile memory dies stacked with the processor; and
one or more nonvolatile memory dies stacked with the processor and the volatile memory dies,
wherein the processor transfers data stored in the volatile memory die to the nonvolatile memory die in response to a backup signal, and transfers the data stored in the nonvolatile memory die to the volatile memory die in response to a recovery signal.

2. The memory system according to claim 1, wherein when the data are transferred from the volatile memory die to the nonvolatile memory die, the processor generates a nonvolatile memory address signal corresponding to a volatile memory address signal, and
stores correspondence information between the volatile memory address signal and the nonvolatile memory address signal.

3. The memory system according to claim 2, wherein when the data are transferred from the nonvolatile memory die to the volatile memory die, the processor outputs a nonvolatile memory address signal corresponding to the volatile memory address signal based on the correspondence information.

4. The memory system according to claim 1, wherein the processor comprises:
a volatile memory controller configured to control the volatile memory die;
a nonvolatile memory controller configured to control the nonvolatile memory die; and
an arbiter configured to relay communication among a host, the volatile memory controller, and the nonvolatile memory controller,
wherein the arbiter provides a command to the volatile memory controller and the nonvolatile memory controller in response to the backup signal and a recovery signal.

5. The memory system according to claim 4, wherein the volatile memory controller generates a read signal in response to a command based on the backup signal, and reads data from the volatile memory die in response to the read signal and a volatile memory address signal, and
the nonvolatile memory controller generates a write signal in response to the command based on the backup signal, and writes the data read from the volatile memory die into the nonvolatile memory die in response to the write signal and a nonvolatile memory address signal corresponding to the volatile memory address signal.

6. The memory system according to claim 4, wherein the nonvolatile memory controller generates a read signal in response to a command based on the recovery signal, and reads data from the nonvolatile memory die in response to the read signal and a nonvolatile memory address signal corresponding to a volatile memory address signal, and
the nonvolatile memory controller generates a write signal in response to the command based on the recovery signal, and writes the data read from the nonvolatile memory die into the volatile memory die in response to the write signal and the volatile memory address signal.

7. The memory system according to claim 1, wherein the processor senses the temperature of the volatile memory die, and generates the backup signal and the recovery signal based on the sensing result.

8. The memory system according to claim 4, wherein the arbiter comprises an address mapping unit configured to receive a volatile memory address signal and provide the received volatile memory address signal to the volatile memory controller,
generate a nonvolatile memory address signal corresponding to the volatile memory address signal,
provide the generated nonvolatile memory address signal to the nonvolatile memory controller, and
store correspondence information between the volatile memory address signal and the nonvolatile memory address signal.

9. The memory system according to claim 7, wherein the arbiter further comprises a data buffering unit configured to delay a data read from the volatile memory die,
output the delayed data to the nonvolatile memory die or delay the data read from the nonvolatile memory die, and
output the delayed data to the volatile memory die.

10. A memory system comprising:
a processor configured to communicate with a host;
a logic die configured to communicate with the processor;
one or more volatile memory dies stacked with the logic die; and
one or more nonvolatile memory dies stacked with the logic die and the volatile memory dies,
wherein the logic die transfers data stored in the volatile memory die to the nonvolatile memory die in response to a backup signal, and transfers the data stored in the nonvolatile memory die to the volatile memory die in response to a recovery signal.

11. The memory system according to claim 10, wherein when the data are transferred from the volatile memory die to the nonvolatile memory die, the logic die generates a nonvolatile memory address signal corresponding to the volatile memory address signal in response to a volatile memory address signal, and
stores correspondence information between the volatile address signal and the nonvolatile memory signal.

12. The memory system according to claim 11, wherein when the data are transferred from the nonvolatile memory die to the volatile memory die, the logic die generates the nonvolatile memory address signal corresponding to the volatile memory address signal based on the correspondence information.

13. The memory system according to claim 12, wherein the logic die comprises:
a volatile memory controller configured to control the volatile memory die;
a nonvolatile memory controller configured to control the nonvolatile memory die; and
an arbiter configured to relay communication among the processor, the volatile memory controller, and the nonvolatile memory controller,
wherein the arbiter provides a command to the volatile memory controller and the nonvolatile memory controller in response to the backup signal and the recovery signal.

14. The memory system according to claim 13, wherein the volatile memory controller generates a read signal in response to a command based on the backup signal, and reads data from the volatile memory die in response to the read signal and a volatile memory address signal, and
the nonvolatile memory controller generates a write signal in response to the command based on the backup signal, and writes the data read from the volatile memory die to the nonvolatile memory die in response to the write signal and a nonvolatile memory address signal corresponding to the volatile address signal.

15. The memory system according to claim 13, wherein the nonvolatile memory controller generates a read signal in response to the command based on the recovery signal, and reads data from the nonvolatile memory die in response to the read signal and a nonvolatile memory address signal corresponding to a volatile memory address signal, and
the volatile memory controller generates a write signal in response to a command based on the recovery signal, and writes the data read from the nonvolatile memory die to the volatile memory die in response to the write signal and the volatile memory address signal.

16. The memory system according to claim 13, wherein the logic die senses the temperature of the volatile memory die, and generates the backup signal and the recovery signal based on the sensing result.

17. The memory system according to claim 13, wherein the arbiter comprises an address mapping unit configured to receive a volatile memory address signal and provide the received volatile memory address signal to the volatile memory controller,
generate a nonvolatile memory address signal corresponding to the volatile memory address signal and provide the generated nonvolatile memory address signal to the nonvolatile memory controller, and
store correspondence information between the volatile address signal and the nonvolatile address signal.

18. The memory system according to claim 13, wherein the arbiter further includes a data buffering unit configured to delay a data read from the volatile memory die and output the delayed data to the nonvolatile memory die, or delay the data read from the nonvolatile memory die and output the delayed data to the volatile memory die.

19. A memory system comprising:
a processor;
one or more volatile memory dies stacked with a nonvolatile memory die and the processor,
wherein the processor performs a data transfer operation when a backup signal and/or a recovery signal is generated.

20. The memory system according to claim 19, wherein the processor generate the backup signal when volatile memory dies are heated to a predetermined temperature to decrease a retention time corresponding to a period at which a refresh operation is to be performed.

21. The memory system according to claim 19, wherein the processor generate the recovery signal when a temperature of the volatile memory dies is decreased to a predetermined temperature to increase a retention time at which a refresh operation is to be performed.

22. The memory system according to claim 20, wherein data stored in the volatile memory dies is transferred to the nonvolatile memory die to decrease the retention time at which the refresh operation is to be performed.

23. The memory system according to claim 19, wherein the processor generates the backup signal to reduce an amount of current consumed during a refresh operation of the volatile memory dies.

24. The memory system according to claim 22, wherein the processor provides a volatile memory address signal to the volatile memory dies and a nonvolatile memory address signal to the nonvolatile memory die to transfer data from the volatile memory dies to the nonvolatile memory die.

25. The memory system according to claim 24, further comprising:
an arbiter configured to relay a communication between a volatile memory controller and a nonvolatile memory controller.

26. The memory system according to claim 25, wherein the arbiter comprises an address mapping unit configured to provide the volatile memory address signal to the volatile memory controller in response to the backup signal.

27. The memory system according to claim 25, wherein the arbiter comprises a data buffering unit to delay a data read from the volatile memory dies to the nonvolatile memory die until the data read has been written into the nonvolatile memory die, and
delay the data read from the nonvolatile memory die to the volatile memory dies until the data read has been written into the volatile memory dies.
